(19) United States
(12) Patent Application Publication
(10) Pub. No.: US 2025/0044674 A1
(43) Pub. Date: Feb. 6, 2025

(54) WAVELENGTH CONVERSION DEVICE AND PROJECTION DEVICE

(71) Applicant: Coretronic Corporation, Hsin-Chu (TW)

(72) Inventors: Jia-Hong Dai, Hsin-Chu (TW); Te-Ying Tsai, Hsin-Chu (TW); Shao-Peng Su, Hsin-Chu (TW)

(73) Assignee: Coretronic Corporation, Hsin-Chu (TW)

(21) Appl. No.: 18/788,111

(22) Filed: Jul. 29, 2024

(30) Foreign Application Priority Data
Jul. 31, 2023 (CN) 202310946696.6

(51) Int. Cl. G03B 21/20; G03B 21/16

(52) U.S. Cl. CPC G03B 21/204; G03B 21/16

(57) ABSTRACT

A wavelength conversion device includes a wavelength conversion element, at least one condenser lens, at least one fixing device, a heat dissipation wind flow device, and a wind guide structure. The wavelength conversion element includes a substrate, a wavelength conversion layer, and a driving component. The substrate has a first surface and a second surface opposite to each other. The wavelength conversion layer is disposed on the first surface, and the driving component drives the substrate to rotate about a rotary shaft of the driving component as a central axis. The condenser lens is arranged on one side of the first surface of the wavelength conversion element and fixed to the fixing device. The fixing device has at least one vent. The wind guide structure is connected to the heat dissipation wind flow device and the vent.

### CROSS-REFERENCE TO RELATED APPLICATION

This application claims the priority benefit of China application serial no. 202310946696.6, filed on Jul. 31, 2023. The entirety of the above-mentioned patent application is hereby incorporated by reference herein and made a part of this specification.

### BACKGROUND

### Technical Field

The disclosure relates to an optical device, and in particular to a wavelength conversion device and a projection device adopting the wavelength conversion device.

### Description of Related Art

Most of existing laser projectors use laser phosphor wheel. In a laser projector, a condenser lens is generally disposed in front of a phosphor wheel and is configured to receive incident light and excited light. Currently, a commonly used method for dissipating heat from the condenser lens uses a wind flow generated by rotation of the phosphor wheel. However, such a wind flow may not effectively dissipate heat from the condenser lens, resulting in that the condenser lens overheats and breaks.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

An embodiment of the disclosure provides a wavelength conversion device which includes a wavelength conversion element, at least one condenser lens, at least one fixing device, a heat dissipation wind flow device, and a wind guide structure. The wavelength conversion element includes a substrate, a wavelength conversion layer, and a driving component. The substrate has a first surface and a second surface opposite to each other. The wavelength conversion layer is disposed on the first surface, and the driving component drives the substrate to rotate about a rotary shaft of the driving component as a central axis. The condenser lens is arranged on one side of the first surface of the wavelength conversion element and is fixed to the fixing device. The fixing device has at least one vent. The wind guide structure is connected to the heat dissipation wind flow device and the vent.

The disclosure further provides a projection device which includes the above-mentioned wavelength conversion device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2 is a schematic view of a wavelength conversion device of the projection device in FIG. 1.

FIG. 3A is a schematic three-dimensional view of a projection device according to another embodiment of the disclosure.

FIG. 3B is a schematic side view of FIG. 3A from another perspective.

FIG. 3C is a schematic three-dimensional view of a wavelength conversion device of the projection device in FIG. 3A.

FIG. 3D is a schematic three-dimensional view of FIG. 3C from another perspective.

FIG. 3E is a schematic side view of FIG. 3D from another perspective.

FIG. 3F is an enlarged schematic three-dimensional view of a fixing device and a condenser lens in FIG. 3D.

FIG. 3G is a schematic view of a relative position of a vent and the condenser lens in FIG. 3F.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used Referring to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a wavelength conversion device which has good heat dissipation efficiency. The disclosure further provides a projection device which includes the above-mentioned wavelength conversion device and exhibits improved projection quality and product competitiveness.

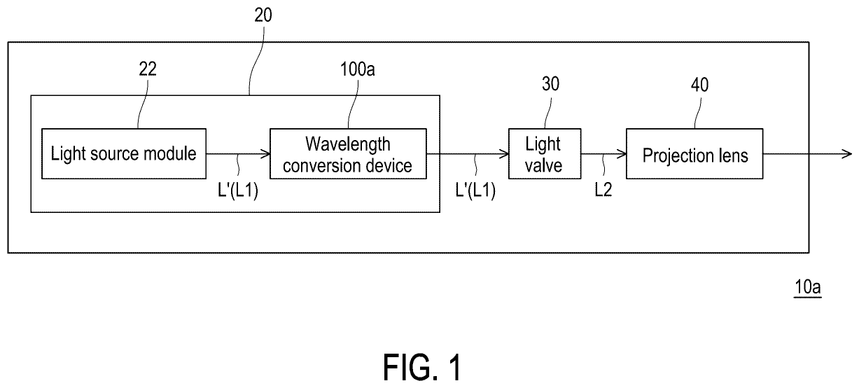

FIG. 1 is a schematic view of a projection device according to an embodiment of the disclosure. Referring to FIG. 1, in this embodiment, a projection device 10a includes an illumination module 20, a light valve 30, and a projection lens 40. The illumination module 20 is configured to provide an illumination beam L1. The illumination module 20 includes a light source module 22 and a wavelength conversion device 100a. The light source module 22 is configured to provide an excitation beam L′ (e.g., blue laser). The wavelength conversion device 100a is, for example, a phosphor wheel, and is configured to receive the excitation beam L′. The wavelength conversion device 100a is disposed on a transmission path of the excitation beam L′, and is configured to receive the excitation beam L′ so as to generate converted beams with wavelengths different from a wavelength of the excitation beam L′. Here, the illumination beam L1 includes the excitation beam L′ and a converted beam. The excitation beam L′ and the converted beam are, for example, sequentially transmitted out of the illumination module 20, but the disclosure is not limited thereto. The light valve 30 is disposed on a transmission path of the illumination beam L1 and is configured to convert the illumination beam L1 into an image beam L2. The projection lens 40 is disposed on a transmission path of the image beam L2 and is configured to project the image beam L2 out of the projection device 10a.

Further, the light source module 22 used in this embodiment is, for example, a laser diode (LD), such as a laser diode bank. Specifically, any light source which meets the volume requirement may be implemented according to the actual design, and the disclosure is not limited thereto. The light valve 30 is, for example, a reflective optical modulator such as a liquid crystal on silicon panel (LCoS panel) or a digital micro-mirror device (DMD). In an embodiment, the light valve 30 is, for example, a transmissive optical modulator such as a transparent liquid crystal panel, an electro-optical modulator, a magneto-optic modulator, or an acousto-optic modulator (AOM), but this embodiment does not limit the light valve 30 to a certain type or form. Detail steps and implementation manner of a method for modulating the illumination beam L1 into the image beam L2 by the light valve 30 will be omitted since sufficient teachings, suggestions and descriptions of implementation can be obtained from common knowledge in the art. The projection lens 40 includes, for example, one optical lens or a combination of multiple optical lenses with a diopter, such as various combinations of non-planar lenses including biconcave lenses, biconvex lenses, concave-convex lenses, convex-concave lenses, plano-convex lenses, and plano-concave lenses. In an embodiment, the projection lens 40 may also include a planar optical lens to project the image beam L2 from the light valve 30 out of the projection device 10a in a reflective or a transmissive manner. Here, this embodiment does not limit the projection lens 40 to a certain type or form.

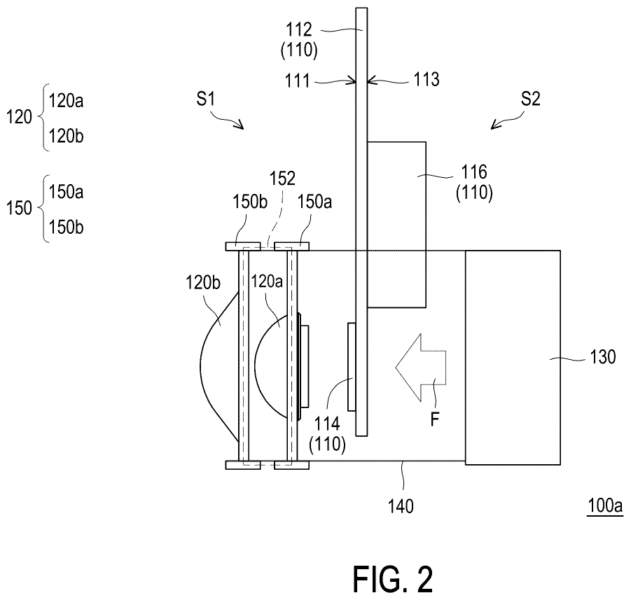

FIG. 2 is a schematic view of a wavelength conversion device of the projection device in FIG. 1. In this embodiment, the wavelength conversion device 100a includes a wavelength conversion element 110, at least one condenser lens 120, at least one fixing device 150, a heat dissipation wind flow device 130, and a wind guide structure 140.

Further, in this embodiment, the wavelength conversion element 110 includes a substrate 112, a wavelength conversion layer 114, and a driving component 116. The substrate 112 has a first surface 111 and a second surface 113 opposite to each other, where a material of the substrate 112 is, for example, aluminum, aluminum alloy, copper, stainless steel, glass with a reflective layer or plastic with a reflective layer, but is not limited thereto. A first side S1 of the wavelength conversion element 110 is, for example, a space located at one side of the first surface 111, and a second side S2 of the wavelength conversion element 110 is, for example, a space located at one side of the second surface 113. That is, the first side S1 and the second side S2 are separated by the substrate 112. In an embodiment, the wavelength conversion element 110 may further include an optical plate to define a disc shape with the substrate 112, where a material of the optical plate is, for example, glass or plastic. In an embodiment, the optical plate may be provided with a reflective layer to reflect blue laser, but is not limited thereto. The wavelength conversion layer 114 is disposed on the first surface 111, where the wavelength conversion layer 114 is, for example, a phosphor layer, but is not limited thereto. The driving component 116 is, for example, disposed on one side of the second surface 113, and drives the substrate 112 to rotate about a rotary shaft of the driving component 116 as a central axis. The driving component 116 is arranged coaxially with the substrate 112, where the driving component 116 is, for example, a motor, but is not limited thereto. In this embodiment, the excitation beam L′ from the light source module 22 is first transmitted to the at least one condenser lens 120, penetrates the at least one condenser lens 120 and is then transmitted to the wavelength conversion layer 114 to generate the converted beam. The converted beam is transmitted to the at least one condenser lens 120 by being reflected by the substrate 112 (or other reflective elements), and is then transmitted toward the light valve 30.

In this embodiment, the at least one condenser lens 120 includes a first condenser lens 120a and a second condenser lens 120b, where the first condenser lens 120a is located between the wavelength conversion element 110 and the second condenser lens 120b. Furthermore, the wavelength conversion device 100a of this embodiment includes at least one fixing device 150. Here, in this embodiment, the number of the at least one fixing device 150 is the same as the number of the at least one condenser lens 120, where the at least one fixing device 150 includes a fixing device 150a and a fixing device 150b. The first condenser lens 120a is fixed to the fixing device 150a, and the second condenser lens 120b is fixed to the fixing device 150b. In other embodiments, the fixing device 150a and the fixing device 150b may be integrated into one piece, that is, the number of the at least one fixing device 150 is one. The at least one fixing device 150 may fix the first condenser lens 120a and the second condenser lens 120b at the same time, so that a spacing is provided between the first condenser lens 120a and the second condenser lens 120b, and the first condenser lens 120a and the second condenser lens 120b are disposed on one side (that is, the first side S1; the front side space of the wavelength conversion element 110) of the first surface 111 of the wavelength conversion element 110. Further, an orthographic projection area of the first condenser lens 120a and the second condenser lens 120b on the first surface 111 overlaps a partial area of the wavelength conversion layer 114.

The at least one fixing device 150 has at least one vent 152. In this embodiment, the at least one vent 152 is, for example, located between the fixing device 150a and the fixing device 150b. As shown in FIG. 2, the at least one vent 152 exposes a part of the at least one condenser lens 120 (for example, the first condenser lens 120a. i.e., an orthographic projection area of the at least one vent 152 on a reference plane overlaps at least a part of an orthographic projection area of the first condenser lens 120a on the reference plane, as shown in FIG. 2, the reference plane is parallel to the at least one vent 152). The wind guide structure 140 is connected between the heat dissipation wind flow device 130 and the at least one vent 152 to guide a wind flow F generated by the heat dissipation wind flow device 130 to the at least one vent 152, so as to dissipate heat from the at least one condenser lens 120. In this embodiment, the heat dissipation wind flow device 130 is disposed on the second side S2 (that is, one side of the second surface 113 of the wavelength conversion element 110; the rear side space of the wavelength conversion element 110) of the wavelength conversion element 110, and the wind guide structure 140 is disposed extending from the second side S2 to the first side S1. In other embodiments, the heat dissipation wind flow device 130 may be arranged in an area on a different side of the wavelength conversion element 110 according to needs and space constraints.

In this embodiment, heat of the first condenser lens 120a and the second condenser lens 120b can be dissipated by not only a wind flow generated by rotation of the wavelength conversion element 110 but also the wind flow F generated by the heat dissipation wind flow device 130 additionally provided on the second side S2 of the wavelength conversion element 110 through guidance by the wind guide structure 140. That is to say, the wind flow F generated by the heat dissipation wind flow device 130 may cool the first condenser lens 120a and the second condenser lens 120b at the same time, thereby effectively dissipating heat. In a simulation experiment, at laser power of 2.2 A, the temperature of the first condenser lens 120a and the second condenser lens 120b may be effectively reduced by 17%. In short, the wavelength conversion device 100a of this embodiment has a good heat dissipation effect and reduces the working temperature of the at least one condenser lens 120 arranged in front of the wavelength conversion element 110, thereby avoiding overheating of elements and improving projection quality.

Other embodiments will be described below as examples. It should be noted here that the reference numerals and a part of the content of the foregoing embodiments will be applied to the following embodiments, where the same reference numerals are used to represent the same or similar elements, and descriptions of the same technical contents will be omitted. Please refer to the foregoing embodiments for the omitted descriptions which will not be repeated in the following embodiments.

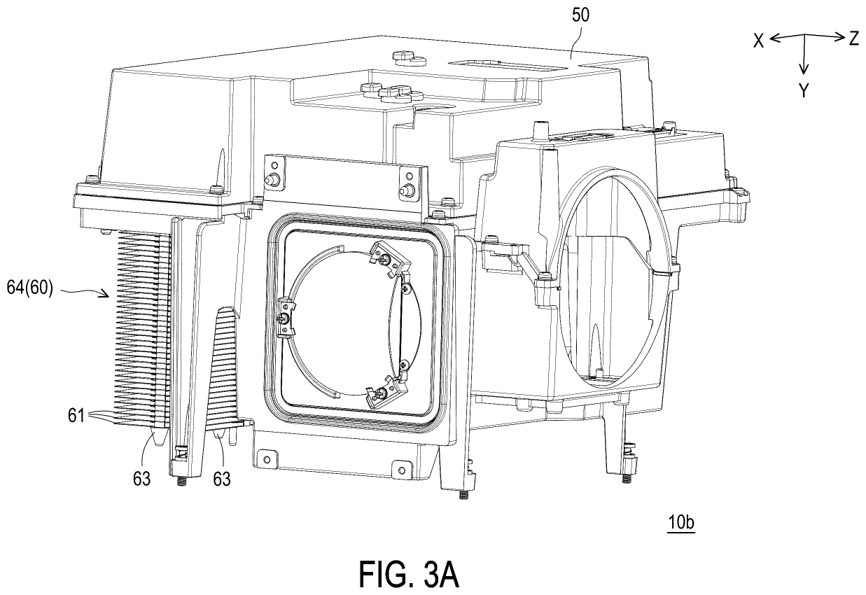

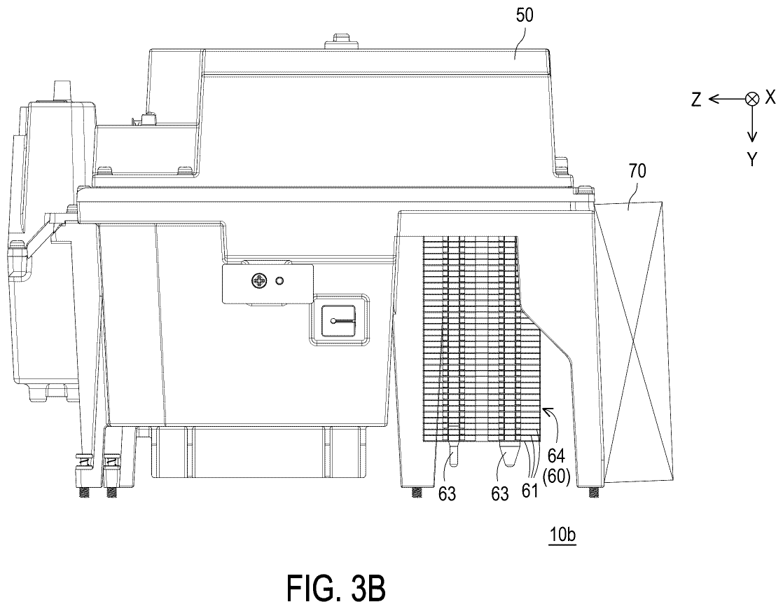

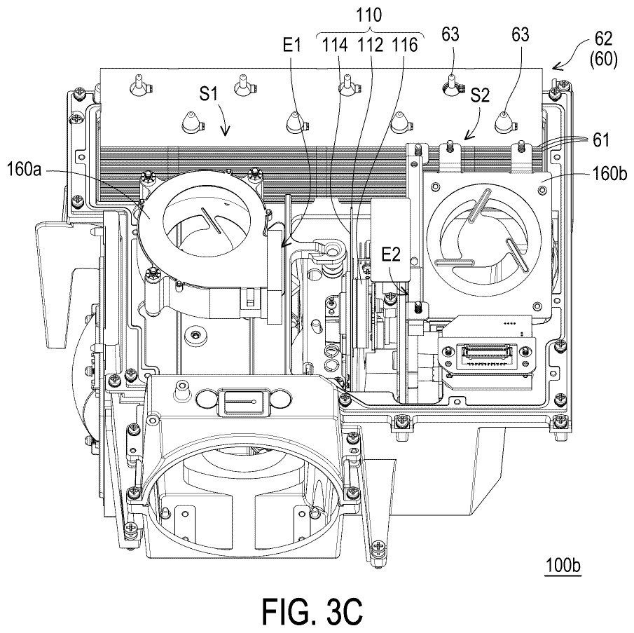

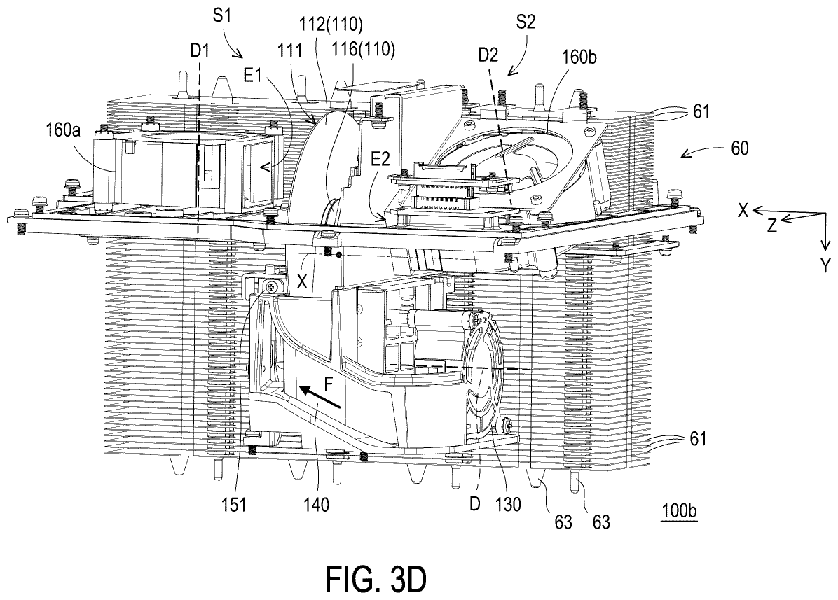

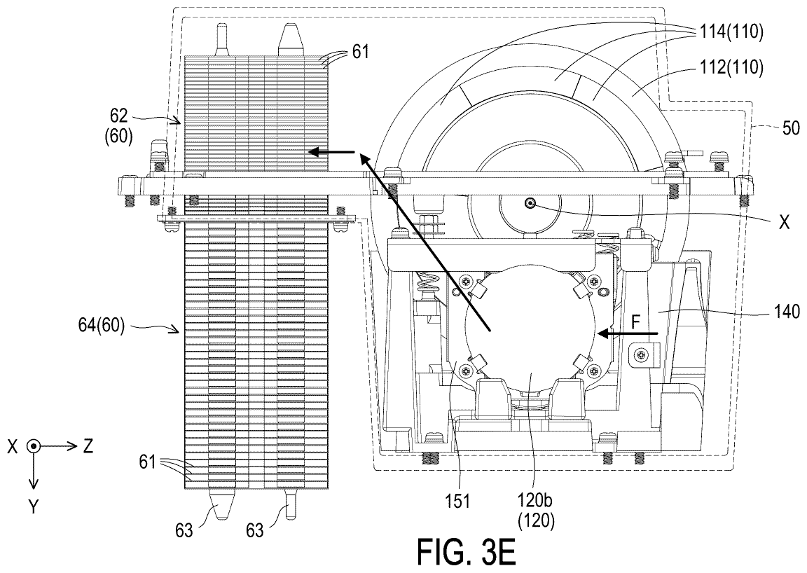

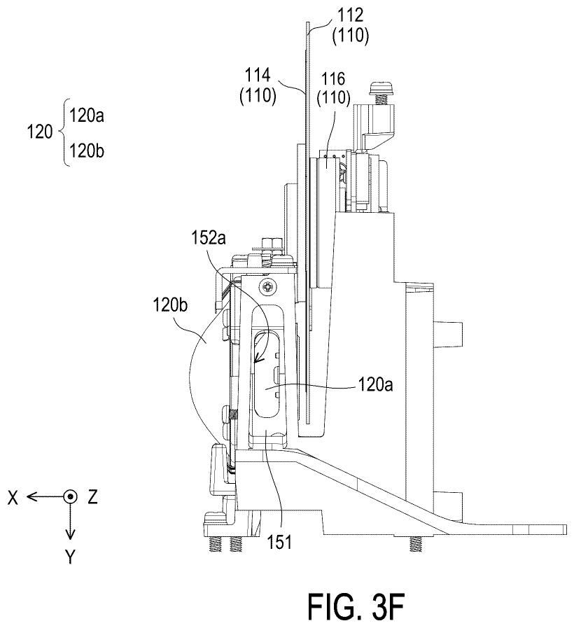

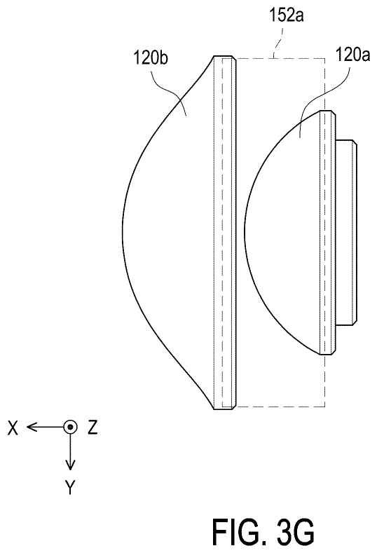

FIG. 3A is a schematic three-dimensional view of a projection device according to another embodiment of the disclosure. FIG. 3B is a schematic side view of FIG. 3A from another perspective. FIG. 3C is a schematic three-dimensional view of a wavelength conversion device of the projection device in FIG. 3A. FIG. 3D is a schematic three-dimensional view of FIG. 3C from another perspective. FIG. 3E is a schematic side view of FIG. 3D from another perspective. FIG. 3F is an enlarged schematic three-dimensional view of a fixing device and a condenser lens in FIG. 3D. FIG. 3G is a schematic view of a relative position of a vent and the condenser lens in FIG. 3F. For convenience, a upper part of a housing is omitted from FIG. 3C and a housing is omitted from FIG. 3D, and a housing in FIG. 3E and the vent in FIG. 3G are shown by broken lines.

Referring to FIG. 3A, FIG. 3D, FIG. 3E, and FIG. 3F together, in this embodiment, a projection device 10b further includes a housing 50, where the wavelength conversion element 110, the first condenser lens 120a, the second condenser lens 120b, the heat dissipation wind flow device 130, and the wind guide structure 140 are disposed inside the housing 50. Referring to FIG. 3A, FIG. 3B, and FIG. 3E together, the projection device 10b of this embodiment further includes a heat dissipation component 60, where the heat dissipation component 60 includes a first heat dissipation part 62 and a second heat dissipation part 64 connected to each other. The first heat dissipation part 62 is disposed inside the housing 50 and is located at a lateral side of the wavelength conversion element 110. The second heat dissipation part 64 is disposed outside the housing 50. Here, the heat dissipation component 60 includes a heat dissipation fin group 61 and at least one heat conduction structure 63 (a plurality of heat conduction structures 63 are schematically illustrated) penetrating through the heat dissipation fin group 61. The first heat dissipation part 62 includes one part of the heat dissipation fin group 61 and one part of at least one heat conduction structure 63. The second heat dissipation part 64 includes the other part of the heat dissipation fin group 61 and the other part of the at least one heat conduction structure 63. In an embodiment, the heat dissipation fin group 61 is, for example, formed by stacking a plurality of metal sheets (each metal sheet is, for example, parallel to an XZ plane), and the heat conduction structure 63 is, for example, a heat pipe (each heat pipe, for example, extends along a Y direction, that is, a direction in which the plurality of metal sheets are arranged). Some of the metal sheets (i.e., one part of the heat dissipation fin group 61) are arranged inside the housing 50 and others of the metal sheets (i.e., the other part of the heat dissipation fin group 61) are arranged outside the housing 50. The heat pipe extends from the inside to the outside of the housing 50, but is not limited thereto. As shown in FIG. 3B, the projection device 10b of this embodiment may further include an outer wind flow device 70. The outer wind flow device 70 is disposed outside the housing 50 and adjacent to the second heat dissipation part 64 of the heat dissipation component 60, and is configured to cool the heat dissipation component 60, thereby reducing the air temperature inside the housing 50.

Next, referring to FIG. 2, FIG. 3C, and FIG. 3D together, a wavelength conversion device 100b of this embodiment is similar to the wavelength conversion device 100a in FIG. 2, and the main differences between the two lie in that: in this embodiment, the wavelength conversion device 100b further includes a first wind flow device 160a and a second wind flow device 160b (as shown in FIG. 3C and FIG. 3D). The first wind flow device 160a is located at the first side S1, and a first air outlet E1 of the first wind flow device 160a faces at least a part of the wavelength conversion layer 114 of the wavelength conversion element 110. The second wind flow device 160b is located in the second side S2, and a second air outlet E2 of the second wind flow device 160b faces the wavelength conversion element 110. The wavelength conversion element 110 is taken as a reference, the front side space of the wavelength conversion element 110 (the first surface 111 of the wavelength conversion element 110 is, for example, parallel to a YZ plane) may be defined as the first side S1, and the rear side space of the wavelength conversion element 110 may be defined as the second side S2. A side space adjacent to the first side S1 and the second side S2 may be defined as the lateral side, and the heat dissipation component 60 is located at the lateral side, as shown in FIG. 3C.

As shown in FIG. 3D and FIG. 3E, the wavelength conversion element 110 has a central axis X (the central axis X is, for example, parallel to the X axis), and the heat dissipation wind flow device 130 and the second wind flow device 160b are located at different sides of the central axis X. That is, the heat dissipation wind flow device 130 is located below the central axis X, and the second wind flow device 160b is located above the central axis X (that is, the central axis X is located between the heat dissipation wind flow device 130 and the second wind flow device 160b). The first wind flow device 160a and the second wind flow device 160b are located at the same side of the central axis X, that is, the first wind flow device 160a and the second wind flow device 160b are located above the central axis X. The first wind flow device 160a and the second wind flow device 160b are configured to cool the wavelength conversion element 110, and hot wind is subjected to heat dissipation by the heat dissipation component 60 and then used to cool the wavelength conversion element 110 again. Referring to FIG. 3D, FIG. 3E, and FIG. 3F, the heat dissipation wind flow device 130 is located below the second wind flow device 160b and guides the wind flow F through the wind guide structure 140 to cool the first condenser lens 120a and the second condenser lens 120b at the same time. With such a configuration, the original system volume can be maintained and space utilization can be improved.

Furthermore, referring to FIG. 3D again, a first rotation axis D1 (the first rotation axis D1 is, for example, parallel to the Y axis) of the first wind flow device 160a is perpendicular to a rotation axis D (the rotation axis D is, for example, parallel to the X axis) of the heat dissipation wind flow device 130. A second rotation axis D2 of the second wind flow device 160b is not parallel and not perpendicular to the first rotation axis D1 (the first rotation axis D1 is, for example, parallel to the YZ plane. This means that the second wind flow device 160b is arranged in a different direction from the first wind flow device 160a. Here, the wind flow device is, for example, an axial flow device, and the rotation axis is, for example, a revolving axis of a fan blade of the axial flow device. The second rotation axis D2 is inclined relative to an extension direction of the heat conduction structure 63 of the heat dissipation component 60, so as to enable cold air from the heat dissipation fin group 61 to be provided to the second wind flow device 160b.

Referring to FIG. 3D, FIG. 3E, and FIG. 3F together, an orthographic projection of the second air outlet E2 of the second wind flow device 160b on the first surface 111 of the wavelength conversion element 110 is located between an orthographic projection of the first air outlet E1 of the first wind flow device 160a on the first surface 111 of the wavelength conversion element 110 and an orthographic projection of the at least one condenser lens 120 on the first surface 111 of the wavelength conversion element 110. In this embodiment, the number of at least one fixing device 151 is one, and the at least one fixing device 151 is configured to fix the first condenser lens 120a and the second condenser lens 120b. The at least one fixing device 151 has at least one vent (one vent 152a is schematically illustrated). The vent 152a is, for example, a hole of the fixing device 151. The wind guide structure 140 is connected to the heat dissipation wind flow device 130 and the vent 152a. Referring to FIG. 3D, FIG. 3E, FIG. 3F, and FIG. 3G together, the vent 152a at least exposes the first condenser lens 120a, the wind flow F passes between the first condenser lens 120a and the second condenser lens 120b (i.e., the vent 152a connects to a gap between the first condenser lens 120a and the second condenser lens 120b), and hot wind is subjected to heat dissipation by the heat dissipation component 60. In an embodiment, the vent 152a may further cover at least a part of the wavelength conversion element 110, and the wind flow F may pass through the first condenser lens 120a and the second condenser lens 120b and may simultaneously pass through a side surface of the wavelength conversion element 110.

To sum up, the embodiments of the disclosure have at least one of the following advantages or effects. In the design of the wavelength conversion device of the disclosure, the condenser lens is fixed to the fixing device, and the wind guide structure is connected to the heat dissipation wind flow device and the vent. Thereby, the wind guide structure may guide the wind flow generated by the heat dissipation wind flow device to the vent to dissipate heat from the condenser lens disposed on one side of the first surface of the wavelength conversion element, which may effectively cool the condenser lens. In short, the wavelength conversion device of the disclosure may have a good heat dissipation effect, and the projection device adopting the wavelength conversion device of the disclosure may exhibit improved projection quality and product competitiveness.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion device, comprising: a wavelength conversion element, at least one condenser lens, at least one fixing device, a heat dissipation wind flow device, and a wind guide structure, wherein
the wavelength conversion element comprises a substrate, a wavelength conversion layer, and a driving component, the substrate has a first surface and a second surface opposite to each other, the wavelength conversion layer is disposed on the first surface, and the driving component drives the substrate to rotate about a rotary shaft of the driving component as a central axis;
the at least one condenser lens is arranged on one side of the first surface of the wavelength conversion element and fixed to the at least one fixing device;
the at least one fixing device has at least one vent; and
the wind guide structure is connected to the heat dissipation wind flow device and the at least one vent.

2. The wavelength conversion device according to claim 1, wherein the at least one condenser lens is disposed on a first side of the wavelength conversion element, the heat dissipation wind flow device is disposed on a second side of the wavelength conversion element, and the wind guide structure is disposed extending from the second side to the first side.

3. The wavelength conversion device according to claim 2, further comprising:
a first wind flow device and a second wind flow device, wherein the first wind flow device is located at the first side, a first air outlet of the first wind flow device faces the wavelength conversion element, the second wind flow device is located at the second side, and a second air outlet of the second wind flow device faces the wavelength conversion element.

4. The wavelength conversion device according to claim 3, wherein the heat dissipation wind flow device and the second wind flow device are located at different sides of the central axis, and the first wind flow device and the second wind flow device are located at a same side of the central axis.

5. The wavelength conversion device according to claim 3, wherein a first rotation axis of the first wind flow device is perpendicular to a rotation axis of the heat dissipation wind flow device, and a second rotation axis of the second wind flow device is not parallel to and not perpendicular to the first rotation axis.

6. The wavelength conversion device according to claim 5, wherein an orthographic projection of the second air outlet on the first surface of the wavelength conversion element is located between an orthographic projection of the first air outlet on the first surface and an orthographic projection of the at least one condenser lens on the first surface.

7. The wavelength conversion device according to claim 1, wherein the at least one condenser lens comprises a first condenser lens and a second condenser lens, the first condenser lens is located between the wavelength conversion element and the second condenser lens, and the at least one vent connects to a gap between the first condenser lens and the second condenser lens.

8. The wavelength conversion device according to claim 1, wherein the at least one vent further covers at least a part of the wavelength conversion element.

9. A projection device, comprising: an illumination module, a light valve, and a projection lens, wherein
the illumination module is configured to provide an illumination beam and comprises:
a light source module, configured to provide an excitation beam; and
a wavelength conversion device, disposed on a transmission path of the excitation beam, wherein the wavelength conversion device comprises a wavelength conversion element, at least one condenser lens, at least one fixing device, a heat dissipation wind flow device, and a wind guide structure, wherein
the wavelength conversion element comprises a substrate, a wavelength conversion layer, and a driving component, the substrate has a first surface and a second surface opposite to each other, the wavelength conversion layer is disposed on the first surface, and the driving component drives the substrate to rotate about a rotary shaft of the driving component as a central axis;
the at least one condenser lens is arranged on one side of the first surface of the wavelength conversion element and fixed to the at least one fixing device;
the at least one fixing device has at least one vent; and
the wind guide structure is connected to the heat dissipation wind flow device and the at least one vent;
the light valve is disposed on the transmission path of the illumination beam and configured to convert the illumination beam into an image beam; and
the projection lens is disposed on the transmission path of the image beam and configured to project the image beam out of the projection device.

10. The projection device according to claim 9, further comprising:
a housing, wherein the wavelength conversion element, the at least one condenser lens, the heat dissipation wind flow device, and the wind guide structure are disposed inside the housing.

11. The projection device according to claim 10, further comprising:
a heat dissipation component, comprising a first heat dissipation part and a second heat dissipation part connected to each other, wherein the first heat dissipation part is disposed inside the housing and located at a lateral side of the wavelength conversion element, and the second heat dissipation part is disposed outside the housing.

12. The projection device according to claim 11, further comprising:
an outer wind flow device, disposed outside the housing and adjacent to the second heat dissipation part of the heat dissipation component.

13. The projection device according to claim 11, wherein the heat dissipation component comprises a heat dissipation fin group and at least one heat conduction structure penetrating through the heat dissipation fin group.
